(19) United States
(12) Patent Application Publication
(10) Pub. No.: US 2023/0141013 A1
(43) Pub. Date: May 11, 2023

(54) BEARING ASSEMBLY FOR TRACKER ASSEMBLY AND METHODS OF MAKING AND USING THE SAME

(71) Applicant: SAINT-GOBAIN PERFORMANCE PLASTICS PAMPUS GMBH, Willich (DE)

(72) Inventor: Lukas PLIOSKA, Nettetal (DE)

(21) Appl. No.: 18/053,823

(22) Filed: Nov. 9, 2022

Related U.S. Application Data
(60) Provisional application No. 63/263,771, filed on Nov. 9, 2021.

(51) Int. Cl. H02S 20/32; F16C 17/02; G01S 3/786

(52) U.S. Cl. CPC H02S 20/32; F16C 17/02; G01S 3/7861; F16C 2362/00

(57) ABSTRACT

A power generation structure bearing assembly including a housing adapted to support a rail, where the housing includes a first housing member operatively attached to a support beam having a central axis, and an second housing member operatively attached to the rail, where the housing allows for movement of the rail in three degrees of freedom relative to the central axis with a mechanical stop on movement in at least one degree of freedom.

### CROSS-REFERENCE TO RELATED APPLICATION(S)

This application claims priority under 35 U.S.C. § 119(e) to U.S. Provisional Application No. 63/263,771, entitled “BEARING ASSEMBLY FOR TRACKER ASSEMBLY AND METHODS OF MAKING AND USING THE SAME,” by Lukas PLIOSKA, filed Nov. 9, 2021, which is assigned to the current assignee hereof and incorporated herein by reference in its entirety.

### FIELD OF DISCLOSURE

The following disclosure relates to bearing assemblies for tracker assemblies with exemplary uses in renewable energy structures.

### BACKGROUND

Tracking assemblies are typically used in radar, light shelf, antennas, solar panels, automobiles and other applications which require continuous rotary motion. One common example of tracker assembly used in the industry is solar trackers for use with renewable energy source assemblies. Solar trackers conventionally include a mounting means to mount solar panels. The mounting means of the solar tracker is designed to change its orientation of the solar panels so as to reflect the sun's position to maximize efficiency. However, as the industries surrounding renewable energy sources and tracker assemblies continue to mature, improvements in the components responsible for ensuring power generation will be demanded to improve efficiency, provide lower maintenance, increase deployment potential, and lower the cost and ease of installation.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a side view of a power generation structure that includes a tracking assembly in accordance with an embodiment;

FIG. 2A includes an illustration of a side view of a bearing assembly for the tracking assembly in accordance with an embodiment;

FIG. 2B includes an illustration of a side view of a bearing assembly for the tracking assembly in accordance with an embodiment;

FIG. 2C includes a front perspective exploded view of one embodiment of a bearing assembly in accordance with an embodiment;

FIG. 2D includes a front perspective exploded view of one embodiment of a bearing assembly in accordance with an embodiment;

FIG. 3A includes an illustration of a side view of one embodiment of a bearing assembly in accordance with an embodiment;

FIG. 3B includes an illustration of a side view of one embodiment of a bearing assembly in accordance with an embodiment;

FIG. 3C includes an illustration of a side view of one embodiment of a bearing assembly in accordance with an embodiment;

FIG. 4 includes a method of forming a bearing in accordance with an embodiment;

FIG. 5A includes a cross-sectional view of one embodiment of a bearing in accordance with an embodiment;

FIG. 5B includes a cross-sectional view of one embodiment of a bearing in accordance with an embodiment;

FIG. 5C includes a cross-sectional view of one embodiment of a bearing in accordance with an embodiment; and

FIG. 5D includes a cross-sectional view of one embodiment of a bearing in accordance with an embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the bearing and bearing assembly arts.

Embodiments of the invention described herein may include a power generation structure bearing assembly including: a housing adapted to support a rail, where the housing includes a first housing member operatively attached to a support beam having a central axis, and a second housing member operatively attached to the rail, where the housing allows for movement of the rail in three degrees of freedom relative to the central axis with a mechanical stop on movement in at least one degree of freedom.

Embodiments of the invention described herein may include a power generation structure bearing assembly including: a housing adapted to support the rail, the housing including: a first housing member operatively attached to a support beam having a central axis, and a second housing member; where the second housing member includes a core operatively attached rail and a second housing member component, where a low friction material is present at an interface between an exterior surface of core and an interior surface of the second housing member component, where the housing allows for movement of the rail in three degrees of freedom relative to the central axis with a mechanical stop on movement in at least one degree of freedom.

Embodiments of the invention described herein may include a tracker assembly of a power generation structure including: a support beam having a central axis; a rail; and a bearing assembly operatively attached to the support beam and the rail, the bearing assembly including: a first housing member operatively attached to the support beam, and a second housing member; where the second housing member includes a core operatively attached rail and a second housing member component, where a low friction material is present at an interface between an exterior surface of core and an interior surface of the second housing member component, where the housing allows for movement of the rail in three degrees of freedom relative to the central axis with a mechanical stop on movement in at least one degree of freedom.

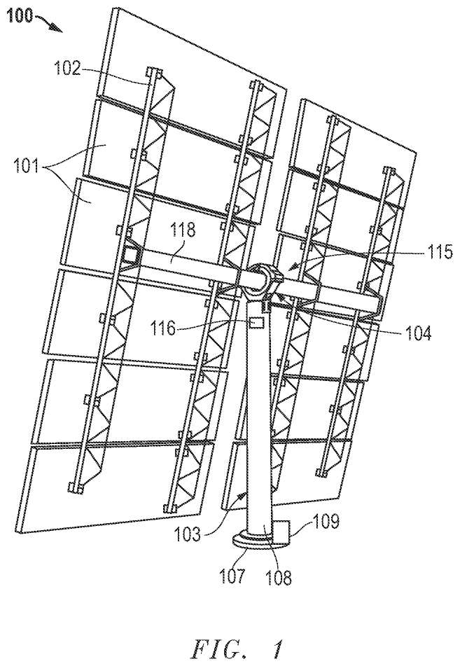

FIG. 1 includes an illustration of a side view of a power generation structure that includes a tracking assembly in accordance with an embodiment. In particular, the tracking assembly 100 may be particularly suitable for utilizing solar power, and converting solar energy to electrical energy. As illustrated, the tracking assembly 100 can include a base 103, including a foundation 107, which may be directly attached to the ground for securing the structure 100 in its location. As further illustrated, the base 103 can include a support beam 108 directly connected to the foundation 107 and extending upward from the foundation 107 for support and connection of other components of the structure 100. As further illustrated, the base 103 can include a power terminal 109 attached to the foundation 107, which may supply energy to motors used to move portions of the structure 100. The ability to adjust the height of the tracking assembly 104 via the power terminal 109 extending the support beam 108 is also contemplated herein.

The power generation structure 100 can further include tracker assembly 104 including a bearing assembly 115 attached to the base 103, and in particular, directly attached to the support beam 108, and configured to move a rail 118 operably connected to the bearing assembly 115. The rail 118 may be adapted to support a photovoltaic panel. The bearing assembly 115 as described herein may refer to a movable interface between at least two components, where one of the components is designed to move relative to the other component. Types of movement can include simple translation (along one axis), compound translation (along two or more axes), simple rotation (around one axis) compound rotation (around two or more axes), and a combination thereof. The tracker assembly 104 can further include a drive mechanism 116 that may include a motor, which aids movement of the bearing assembly 115 and the rail 118. In particular, the drive mechanism 116 can be programmed such that it changes the position of the rail 118, and thus, the position of photovoltaic (solar) panels 101 that may be attached to the rail 118, such that the panels 101 can follow the position of the sun in the sky for efficient collection and/or direction of radiant beams of energy from the sun. As will be appreciated, movement of the rail 118 can facilitate movement of portions of the structure 100, and in particular, panels 101 that are attached to the rail 118 via support structures 102. For example, the rail 118 may be adapted to rotatably support the panels 101 about a rotational or central axis. As illustrated, the structure 100 can include an array of panels 101 attached to a single base 103. According to one embodiment, the panels 101 can be energy conversion structures, such as solar panels, configured to convert radiant energy of the sun into electrical power. In another embodiment, the panels 101 of the article can be reflectors, such as mirrors, designed to re-direct the radiant energy of the sun to nearby energy conversion structures, such as solar panels.

While not illustrated, the structure 100 can include other bearing assemblies, such as between the foundation 107 and the support beam 108 for rotation of the support beam 108 relative to the foundation 107. Moreover, it will be appreciated that other energy conversion structures can utilize a bearing assembly 115, and particularly components disclosed herein within the bearing assembly 115. For example, another suitable energy conversion structure can include a wind turbine, which may include a plurality of propellers (or vanes) extending from a central structure, where the turbines must be allowed to rotate for the generation of electrical power, and thus, may utilize components disclosed herein at a bearing assembly within the structure.

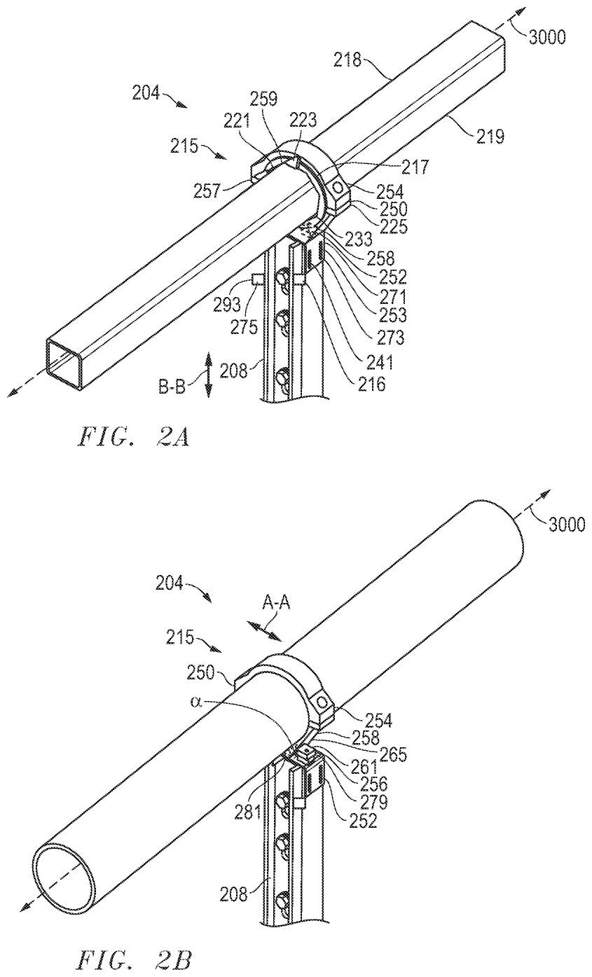

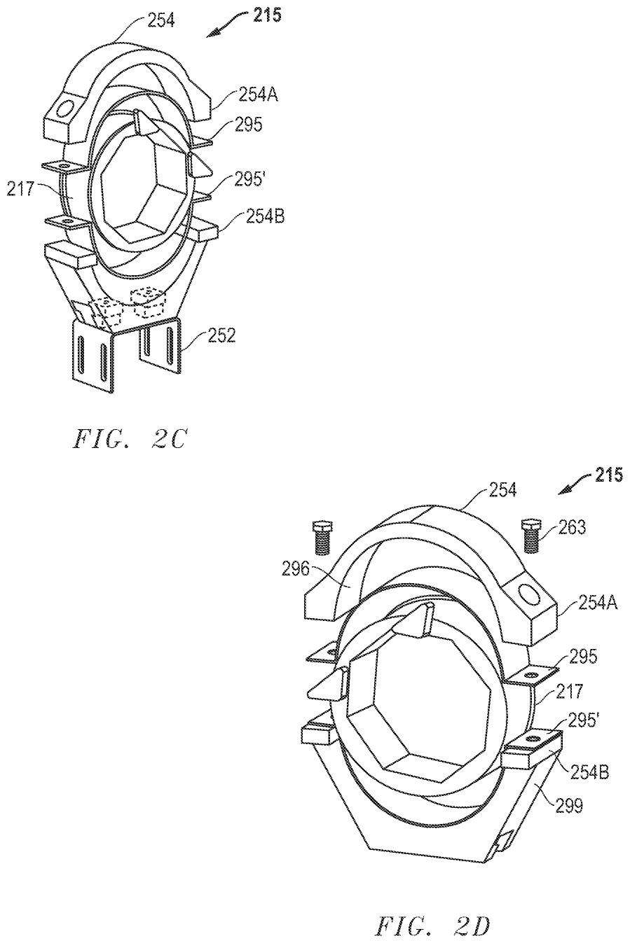

FIG. 2A includes an illustration of a side view of a bearing assembly for the tracking assembly in accordance with an embodiment. The bearing assembly 215 of the tracking assembly 204 may be placed on the support beam 208 and operated operably connected to the drive mechanism 216. The bearing assembly 215 of the tracking assembly 204 may further include a housing 250. The bearing assembly 215 of the tracking assembly 204 or the housing 250 can include a core 217 configured to support the rail 218 directed down a rotational or central axis 3000. In some embodiments, the core 217 may be uniform or may include multiple pieces. As shown in FIG. 2A, an exterior surface 219 of the rail 218 may have a non-circular cross-section when viewed in cross-section perpendicular to the rotational or central axis 3000. In some embodiments, the exterior surface 219 of the rail 218 may have a polygonal cross-section when viewed in cross-section perpendicular to the rotational or central axis 3000. As shown, the exterior surface 219 of the rail 218 may have a square cross-section but triangular, pentagonal, hexagonal, or other polygonal cross-sections are contemplated herein. Further, in some embodiments, the exterior surface 219 of the rail 218 may have an oval, semi-circular, or other cross-section that is non-circular when viewed in cross-section perpendicular to the rotational or central axis 3000. Further as shown in FIG. 2A, an interior surface 221 of the core 217 may have a non-circular cross-section when viewed in cross-section perpendicular to the rotational or central axis 3000. In some embodiments, the interior surface 221 of the core 217 may have a polygonal cross-section when viewed in cross-section perpendicular to the rotational or central axis 3000. As shown, the interior surface 221 of the core 217 may have a square cross-section but triangular, pentagonal, hexagonal, or other cross-sections are contemplated herein. Further, the interior surface 221 of the core 217 may have an oval, semi-circular, or other cross-section that is non-circular when viewed in cross-section perpendicular to the rotational or central axis 3000. The interior surface 221 of the core may be complementary to the exterior surface 219 of the rail 218 so that they are complementary to each other and may generally fix or couple the rail 218 and the core 217 such that they may be rotatable as a single paired component about the rotational or central axis 3000. In other words, the rail 218 and the core 217 may be fixed and rotatable together about a rotational or central axis 3000 due to their paired surfaces. In some embodiments, the core 217 can further include secondary components (not shown) that may facilitate the movement of the rail 218, including for example bearing members, suitable for facilitating the sliding of the rail 218 axially relative to the core 217.

Still referring to FIG. 2A, the bearing assembly 215 of the tracking assembly 204 may further include a housing 250. The housing 250 may be adapted to support the core 217 and the rail 218. In such cases, the rail 218 may have a circular, oval, semi-circular, or other cross-section that is non-circular when viewed in cross-section perpendicular to the rotational or central axis 3000 that couples with the shape of the housing 250. In some embodiments, the housing 250 may be uniform or may include multiple pieces. In some embodiments, the housing 250 may have a first housing member 252 and a second housing member 254. Either of these two members may be uniform or may include multiple pieces. The first housing member 252 may operatively attach to the support beam 208. The second housing member 252 may operatively attach to the rail 218 through the core 217. In some embodiments, the second housing member 252 may include the core 217. As shown in FIG. 2A, the second housing member 254 may be used to at least partially fasten the rail 218 and the core 217 together such that they may not move apart from each other in a radial direction relative to the rotational or central axis 3000. The core 217 and/or rail 218 may be configured to rotate (x-y axis) relative to the housing 250 on a track between the core 217 and/or rail 218 in the second housing member 254 around the rotational or central axis 3000 to allow for a first degree of freedom of movement for the bearing assembly 215 (and the rail 218) about the central axis 3000. The track may be a substantially parabolic shape allowing for axial or rotational movement of the core 217 or rail 218 along the central axis. In a number of embodiments, the core 217 may include a mechanical stop 223 that interacts with a mechanical stop 225 in the second housing member 254 to stop, restrict, or eliminate rotational movement (x-y axis) of the core 217 and/or rail 218 about the central axis 300. The mechanical stops 223, 225 may be at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may stop rotational movement a different way. As shown in FIG. 2A, the mechanical stops 223, 225 each consist of a ramp where a tapered or squared edge in at least one of the ramps 223, 225 contacts the other of the ramps 223, 225 to provide a hard stop on rotation (x-y axis) of the core 217 and/or rail 218 about the central axis 300.

Still referring to FIG. 2A, the first housing member 252 may have an exterior surface 253 and an interior surface 255. The second housing member 254 may have an exterior surface 257 and an interior surface 259. The first housing member 252 and the second housing member 254 of the housing 250 may be contacting or contiguous with each other via a mechanical interface 261 that couples the two pieces together. This mechanical interface 261 may be fixed with at least one fastener 256 to fix or fasten the first housing member 252 and the second housing member 254 together. The fastener 256 may include at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may be attached a different way. In the embodiment shown, the fastener 256 may include tongues 256 on the first housing member 252 and holes 258 in the second housing members 254 that align for the insertion of tongue 256, whereby tightening the core 217 to the beam 208. Further, the tongue 256 may include a plurality of flanges, allowing for the second housing member 254 to tilt upon (or relative to) the first housing member 252 to allow for a second degree of freedom of movement of the bearing assembly 215 (and the rail 218) along (or in-and-out of the plane of/z-axis) the central axis 3000. In a number of embodiments, the first housing member 252 may include a mechanical stop 233 that interacts with a mechanical stop 235 in the second housing member 254 to stop, restrict, or eliminate tilting movement of the core 217 and/or rail 218 along (or in-and-out of the plane of/z-axis) the central axis 3000. The mechanical stops 233, 235 may be at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may stop rotational movement a different way. As shown, the mechanical stop 233 consists of an axial flange 233′ on the tongue 256 of the first housing member 252 where an edge in the axial flange 233′ contacts the holes 258 of the second housing member 254 to provide a hard stop on movement of the core 217 and/or rail 218 along (or in-ad-out of the plane of/z-axis) the central axis 3000. In a number of embodiments, the tilt may be at an angle, α, of at least −60° and not greater than +60°.

Further, FIG. 2B includes a side view of a bearing assembly for the tracking assembly in accordance with an embodiment. The bearing assembly 215 may include any of the components (and features thereof) listed above in FIGS. 2A-2C, including but not limited to, the core 217, the housing 250, the rail 218, and the support beam 208. As shown in FIG. 2B, the mechanical interface 261 may include a bore or groove 265 and the tongues 256 that allows for tongue and groove arrangement allowing for sliding or movement of the first housing member 252 in and out of the second housing member 254 (or vice versa), thereby allowing movement of the bearing assembly 215 in a plane perpendicular to the central axis 3000 along a line A-A (x-axis) to allow for a third degree of freedom of movement for the rail 218 along the central axis 3000. In a number of embodiments, the first housing member 252 may include a mechanical stop 279 that interacts with a mechanical stop 281 in the second housing member 254 to stop, restrict, or eliminate sliding movement of the core 217 and/or rail 218 in a plane perpendicular to the central axis 3000 along a line A-A (x-axis). The mechanical stops 279, 281 may be at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may stop rotational movement a different way. In a number of embodiments, as shown, the tongues 256 of the first housing member 252 may include a mechanical stop 279 that interacts with a mechanical stop 281 in the bore 265 of the second housing member 254 to provide a hard stop sliding movement of the core 217 and/or rail 218 in a plane perpendicular to the central axis 3000 along a line A-A (x-axis).

Referring back to FIG. 2A, the first housing member 252 and the beam 208 may be contacting or contiguous with each other via a mechanical interface 271 that couples the two pieces together. This mechanical interface 271 may be fixed with at least one beam fastener 273 to fix the first housing member 252 and the beam 208 together. The fastener 273 may include at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may be attached a different way. In the embodiment shown, the fastener 723 may include tongues 275 on the beam 208 and tracks or sliding holes 277 in the first housing member 252 that align for the insertion of tongues 275, whereby tightening the housing 250 to the beam 208. Further, the tongues 275 may slide up and down in the sliding holes 277 of the first housing member 252 to allow for movement of the bearing assembly 215 in a plane perpendicular to the central axis 3000 along a line B-B (y-axis) to allow for a fourth degree of freedom of movement for the rail 218 along the central axis 3000. In a number of embodiments, the first housing member 252 may include a mechanical stop 291 that interacts with a mechanical stop 293 in the beam 208 to stop, restrict, or eliminate sliding movement of the core 217 and/or rail 218 in a plane perpendicular to the central axis 3000 along a line B-B (y-axis). The mechanical stops 291, 293 may be at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may stop rotational movement a different way. In a number of embodiments, as shown, the tongues 275 of the beam 208 may include a mechanical stop 293 that interacts with a mechanical stop 291 in the sliding holes 277 of the first housing member 252 to provide a hard stop sliding movement of the core 217 and/or rail 218 in a plane perpendicular to the central axis 3000 along a line B-B (y-axis).

FIG. 2C includes a front perspective exploded view of one embodiment of a bearing assembly in accordance with an embodiment. FIG. 2D includes a front perspective exploded view of one embodiment of a bearing assembly in accordance with an embodiment. The bearing assembly 215 may include any of the components (and features thereof) listed above in FIGS. 2A-2B, including but not limited to, the core 217, the housing 250, the rail 218, or the support beam 208. Referring to FIGS. 2C-2D, the second housing member 254 may have a first second housing member component 254A and a second second housing member component 254B. The first second housing member component 254A may be anchored, fixed or otherwise attached to the rail in the tracker assembly (not shown) down a central axis 3000. The second second housing member component 254B may be anchored, fixed or otherwise attached to the first housing member 252 in the tracker assembly, as described above. Further, the second second housing member component 254B may be anchored, fixed or otherwise attached to the first second housing member 254A in the tracker assembly. The second second housing member component 254B may be anchored, fixed or otherwise attached to the first second housing member 254A by at least one fastener 263 to fix the first second housing member component 254A and the second second housing member component 254B. The fastener 263 may include at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may be attached a different way. The first second housing member component and a second second housing member component may be attached at an acute angle to allow for tilting as described in further detail below. In some embodiments, the fastener 263 may include the low friction material described in more detail below. In the embodiment shown, at least one of the second second housing member component 254B or the first second housing member 254A may include holes that align for the insertion of fastener 263, thereby tightening the second second housing member component 254B to the first second housing member 254A. In this way, the first second housing member component 254A and a second second housing member component 254B may be adapted to allow the second housing member 254 to function as a clamp around at least one of the rail 218 or the core 217. Thereby, this protects the core 217 from the elements around the bearing assembly 215. Further, upon assembly of the bearing assembly, the housing 250 may overlap the core 217 in the axial direction (or in-and-out of the plane of/z-axis) the central axis 3000 to prevent separation of the core 217 and the housing 250 axially. The overlap may include a ramp, flange, or other mechanical component meant to overlap the core 217 but allow rotation of the core 217 within the housing 250. Further, the second second housing member component 254B may include a T-slot 299 to allow for improved ease of assembly and flexible mounting.

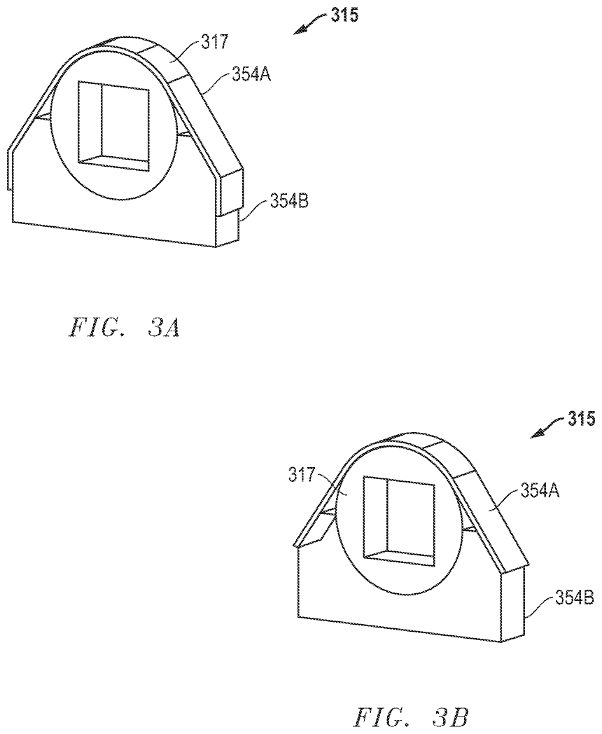

As stated above, the housing may include multiple pieces. FIG. 3A includes an illustration of a side view of one embodiment of a bearing assembly in accordance with an embodiment. FIG. 3B includes an illustration of a side view of one embodiment of a bearing assembly in accordance with an embodiment. As shown in FIG. 3A, the second housing member 354 may have a first second housing member component 354A and a second second housing member component 354B surrounding the core 317. The first second housing member component 354A may include a material strip designed to allow for rotation of the core 317 within the housing 250 as described in further detail below. The second second housing member component 354B may include a base designed to allow for rotation of the core 317 within the housing 250 as described above. As shown in FIG. 3A, the first second housing member component 345A may overlap the sides of the second second housing member component 354B in the radial direction. As shown in FIG. 3B, the first second housing member component 345A may not overlap the sides of the second second housing member component 354B in the radial direction. The first second housing member component 345A and second second housing member component 354B may be anchored, fixed or otherwise attached together via a fastener similar to the fasteners described above.

As stated above, the core may include multiple pieces. FIG. 3C includes an illustration of a side view of one embodiment of a bearing assembly in accordance with an embodiment. As shown in FIG. 3C, the core 317 may include a first core component 317a and a second core component 317b. As shown, the core 317 may have a square cross-section but triangular, pentagonal, hexagonal, or other polygonal cross-sections are contemplated herein. As shown, the core 317 may have a first core component 317a and a second core component 317b that pair together to form a square cross-section but triangular, pentagonal, hexagonal, or other polygonal cross-sections are contemplated herein. The first core component 317a and a second core component 317b may be anchored, fixed or otherwise attached together via a fastener similar to the fasteners described above.

In an embodiment therein, the core, rail, housing, or any components mentioned herein (or any components thereof) may at least partially include a metal. According to certain embodiments, the metal may include iron, copper, titanium, tin, aluminum, alloys thereof, or may be another type of metal. In a number of embodiments, the core, rail, housing, or any components mentioned herein (or any components thereof) may include a polymer. In an embodiment, the core, rail, and or housing (or any components thereof) may be made a plastic polymer. The plastic polymer may be selected from the group including a polyketone, a polyaramid, a polyphenylene sulfide, a polyethersulfone, a polyphenylene sulfone, a polyamideimide, ultra high molecular weight polyethylene, a fluoropolymer, a polybenzimidazole, a polyacetal, polybutylene terephthalate (PBT), polypropylene (PP), polycarbonate (PC), Acrylonitrile butadiene styrene (ABS), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), or any combination thereof. The plastic polymer may be a thermoplastic or thermosetting polymer. In an embodiment therein, the core, rail, and or housing (or any components thereof) may also include glass filler, silica, clay mica, kaolin or other synthetic fillers. In an embodiment therein, the core, rail, and or housing (or any components thereof) may be constructed by at least one of a chamfering, turning, reaming, forging, extruding, molding, sintering, rolling, or casting, injection molding, or 3-D printing. The core, rail, housing, or any components mentioned herein (or any components thereof) of embodiments herein can utilize one or more combinations of features, including particular materials, thicknesses of the material, dimensions of the component, and certain mechanical properties (e.g., stiffness), and chemical inertness that are desired in the industry.

Referring back to FIGS. 2C-2D, in a number of embodiments, a material strip 295 may be mounted, affixed, or otherwise disposed against the exterior surface of the core 217. Further, in a number of embodiments, a material strip may be mounted, affixed, or otherwise disposed against the interior surface 259 of the housing 250 (second housing member 254 as shown in FIGS. 2C-2D). In a number of embodiments, the material strip 295 may be a circumferential ring. In a number of embodiments, as shown in FIGS. 2C-2D, the material strip 295 may include a plurality of material strips 295, 295′. The material strips 295, 295′ may be anchored, fixed or otherwise attached to the second housing member 254 by the at least one fastener 263 described above. The material strip 295 may include a low friction material as described in further detail below. The low friction material may be present at an interface between an exterior surface of core 217 and an interior surface of the second housing member 254. In an embodiment, the low friction material (e.g. material strip) may be fixed to an exterior surface of the core 217 or the rail 218. In an embodiment, the low friction material (e.g. material strip 295, 295′) may be fixed to an interior surface of the second housing member 254, 254A, 254B. In a number of embodiments, an exterior surface of the rail 218, an exterior surface of the core 217, or an interior surface of the second housing member 254, 254A, 254B may include a groove 296 adapted to accommodate the low friction material (e.g. material strip 295, 295′). In an embodiment, the low friction material (e.g. material strip 295, 295′) may be preformed according to the shape of the core 217, the rail 218, or the housing 250.

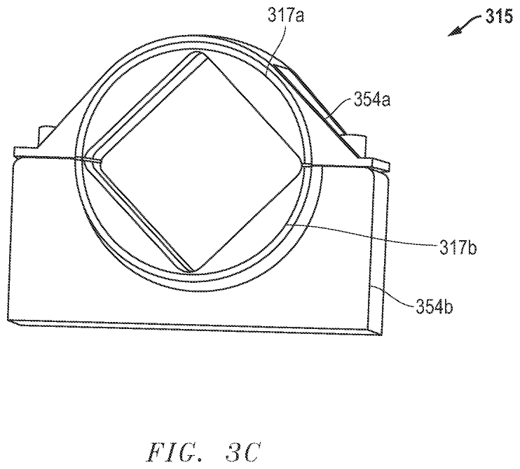

For purposes of illustration, FIG. 4 includes a diagram showing a forming process 410 for forming the material strip. The forming process 410 may include a first step 412 of providing a material including a low friction material. Optionally, the forming process 410 may further include a second step 414 of placing a substrate against the low friction material to form a material strip.

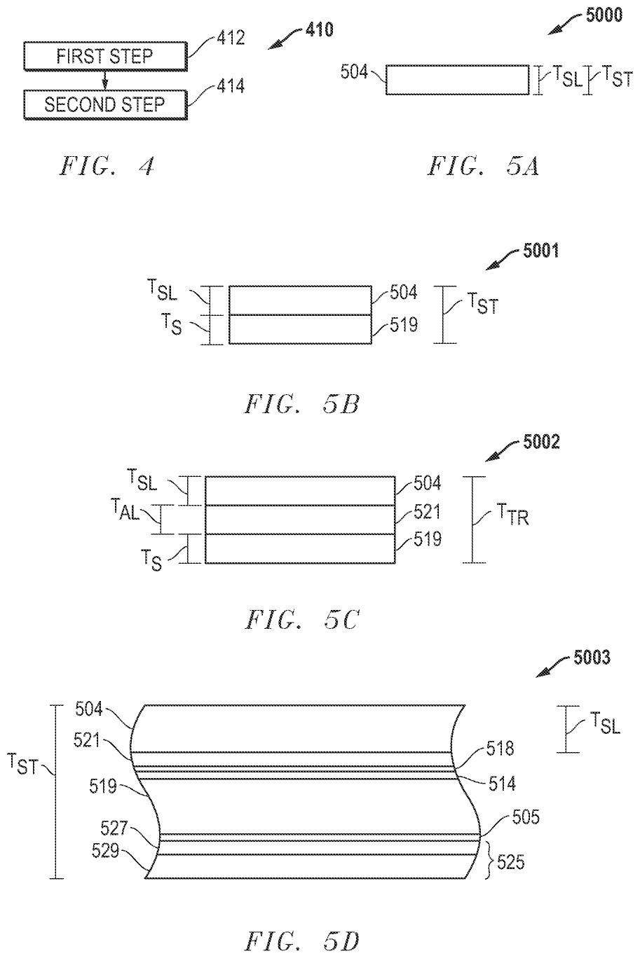

FIG. 5A includes an illustration of a material strip 5000 that may be formed using the first step 412 of the forming process 410 shown in FIG. 4. In a number of embodiments, the material strip 5000 may include a low friction layer 504. In a number of embodiments, the low friction layer 504 can include a low friction material. Low friction materials may include, for example, a polymer, such as a polyketone, a polyaramid, a polyphenylene sulfide, a polyethersulfone, a polypheylene sulfone, a polyamideimide, ultra high molecular weight polyethylene, a fluoropolymer, a polybenzimidazole, a polyacetal, polybutylene terephthalate (PBT), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), or any combination thereof. In an example, the low friction layer 504 includes polyketone, such as polyether ether ketone (PEEK), polyether ketone, polyether ketone, polyether ketone ether ketone, a derivative thereof, or a combination thereof. In an additional example, the low friction layer 504 may include an ultra high molecular weight polyethylene. In another example, the low friction layer 504 may include a fluoropolymer including fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), or ethylene chlorotrifluoroethylene copolymer (ECTFE). The low friction layer 504 may be a thermoplastic or thermosetting polymer. The low friction layer 504 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, iron, bronze, steel, spring steel, stainless steel), a metal alloy (including the metals listed), an anodized metal (including the metals listed) or any combination thereof. Fluoropolymers may be used according to particular embodiments. In an embodiment, the low friction layer 504 may include a woven mesh or an expanded metal grid where the low friction material is embedded within and impregnating the woven mesh or expanded metal grid. The woven mesh or expanded metal grid can include a metal or metal alloy such as aluminum, steel, stainless steel, bronze, or the like. Alternatively, the woven mesh can be a woven polymer mesh made of low friction material.

In a number of embodiments, the low friction layer 504 may further include fillers, including glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof. The fillers may be at least 10 wt % based on the total weight of the low friction layer, such as at least 15 wt %, 20 wt %, 25 wt % or even 30 wt %.

FIG. 5B includes an illustration of another embodiment of a material strip 5001, alternative to the material strip 5000, that may be formed using the first step 612 of the forming process 410 shown in FIG. 4. For purposes of illustration, FIG. 4B shows the layer by layer configuration of a material strip 5001. The material strip 5001 may include a substrate 519. In an embodiment, the substrate 519 can at least partially include a metal. According to certain embodiments, the metal may include iron, copper, titanium, tin, aluminum, alloys thereof, or may be another type of metal. More particularly, the substrate 519 can at least partially include a steel, such as, a stainless steel, carbon steel, or spring steel. For example, the substrate 519 can at least partially include a 301 stainless steel. The 301 stainless steel may be annealed, ¼ hard, ½ hard, ¾ hard, or full hard. Moreover, the steel can include stainless steel including chrome, nickel, or a combination thereof. In an embodiment, the substrate 519 may include a woven mesh or an expanded metal grid. The woven mesh or expanded metal grid can include a metal or metal alloy such as aluminum, steel, stainless steel, bronze, or the like. Alternatively, the woven mesh can be a woven polymer mesh. In an alternate embodiment, the substrate 519 may not include a mesh or grid. Further, the substrate 519 can include a Vickers pyramid number hardness, VPN, which can be ≥350, such as ≥375, ≥400, ≥425, or ≥450. VPN can also be ≤500, ≤475, or ≤450. VPN can also be within a range between, and including, any of the VPN values described herein. In another aspect, the substrate 519 can be treated to increase its corrosion resistance. In particular, the substrate 519 can be passivated. For example, the substrate 519 can be passivated according to the ASTM standard A967. The substrate 519 may be formed by at least one of chamfering, turning, reaming, forging, extruding, molding, sintering, rolling, or casting.

Still referring to FIG. 5B, in a number of embodiments, the material strip 5001 may include substrate 519 (and low friction layer 504 coupled to or overlying the substrate 519. In a more particular embodiment, the material strip 5001 may include a substrate 519 and a plurality of one low friction layers 504 overlying the substrate 519. In a particular embodiment, the low friction layer 504 can be coupled to a surface of the substrate 519 so as to form an interface with another surface of another component. The low friction layer 504 can be coupled to the radially inner surface of the substrate 519. Alternatively, the low friction layer 504 can be coupled to the radially outer surface of the substrate 519. In another alternate embodiment, the substrate 519, as a solid component, woven mesh or expanded metal grid, may be embedded or impregnated with the low friction layer 504. In an embodiment, the substrate 519 may be at least partially encapsulated by the low friction layer 504. That is, the low friction layer 504 may cover at least a portion of the substrate 519.

FIG. 5C includes an illustration of an alternative embodiment of the material strip 5002, alternative to the material strips 5000, 5001, that may be formed into the material strip of the first step 412 of the forming process 410 shown in FIG. 4. For purposes of illustration, FIG. 5C shows the layer by layer configuration of a material strip 5002 of the material strip. According to this particular embodiment, the material strip 5002 may be similar to the material strip 5001 of FIG. 5B, except this material strip 5002 may also include at least one adhesive layer 521 that may couple the low friction layer 504 to the substrate 519 and a low friction layer 504. In another alternate embodiment, the substrate 519, as a solid component, woven mesh or expanded metal grid, may be embedded between at least one adhesive layer 521 included between the low friction layer 504 and the substrate 519.

The adhesive layer 521 may include any known adhesive material common to the ring arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer.

Filler particles (functional and/or nonfunctional) may be added in to the adhesive layer 521 such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof.

In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C.

FIG. 5D includes an illustration of an alternative embodiment of the material strip 5003, alternative to the material strips 5000, 5001, 5002, which may be formed into the material strip of the first step 412 of the forming process 410 shown in FIG. 4. For purposes of illustration, FIG. 5D shows the layer by layer configuration of a material strip 5003. According to this particular embodiment, the material strip 5003 may be similar to the material strip 5002 of FIG. 5C, except this material strip 5003 may also include at least one corrosion protection layer 514, 505, and 518, and a corrosion resistant coating 525 that can include an adhesion promoter layer 527 and an epoxy layer 529 that may couple to the substrate 519 and a low friction layer 504.

The substrate 519 may be coated with corrosion protection layers 514 and 505 including corrosion protection material to prevent corrosion of the material strip 5003 prior to processing. Additionally, a corrosion protection layer 518 can be applied over layer 514. Layers 514 and 505 can include corrosion protection materials including a phosphate of zinc, iron, manganese, or any combination thereof, or a nano-ceramic layer. Further, layers 514 and 505 can include corrosion protection materials including functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Layer 518 can include functional silanes, nano-scaled silane based primers, hydrolyzed silanes, organosilane adhesion promoters, solvent/water based silane primers. Corrosion protection layers 514, 505, and 518 can be removed or retained during processing.

As stated above, the material strip 5003 may further include a corrosion resistant coating 525. The corrosion resistant coating 525 can include an adhesion promoter layer 527 and an epoxy layer 529. The adhesion promoter layer 527 can include corrosion protection materials including phosphate of zinc, iron, manganese, tin, or any combination thereof, or a nano-ceramic layer. The adhesion promoter layer 527 can include corrosion protection materials including functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The adhesion promoter layer 527 can be applied by spray coating, e-coating, dip spin coating, electrostatic coating, flow coating, roll coating, knife coating, coil coating, or the like.

The epoxy layer 529 can be corrosion protection materials including a thermal cured epoxy, a UV cured epoxy, an IR cured epoxy, an electron beam cured epoxy, a radiation cured epoxy, or an air cured epoxy. Further, the epoxy layer 529 can include corrosion protection materials including polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy layer 529 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners such as chromium, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof. Generally, amines can be primary amines, secondary amines, or tertiary amines conforming to the formula R₁R₂R₃N where R can be C_{X}H_{Y}X_{Z}A_{U} as described above. In an embodiment, the epoxy layer 529 can include fillers to improve the conductivity, such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof. The conductive fillers can allow current to pass through the epoxy coating and can increase the conductivity of the material strip as compared to a material strip without conductive fillers. In an embodiment, the epoxy layer 529 can be applied by spray coating, e-coating, dip spin coating, electrostatic coating, flow coating, roll coating, knife coating, coil coating, or the like. Additionally, the epoxy layer 529 can be cured, such as by thermal curing, UV curing, IR curing, electron beam curing, irradiation curing, or any combination thereof. Preferably, the curing can be accomplished without increasing the temperature of the component above the breakdown temperature of any of the low friction layer 504, the adhesive layer 521, the substrate 519, or the adhesion promoter layer 527. Accordingly, the epoxy may be cured below about 250° C., even below about 200° C.

In an embodiment, under step 412 of FIG. 4, any of the layers on the material strip 5000, 5001, 5002, 5003, as described above in reference to FIGS. 5A-5D, can each be disposed in a roll and peeled therefrom to join together under pressure, at elevated temperatures (hot or cold pressed or rolled), by an adhesive, or by any combination thereof. Any of the layers on the material strip 5000, 5001, 5002, 5003, as described above, may be laminated together such that they at least partially overlap one another. Any of the layers on the material strip 5000, 5001, 5002, 5003, as described above, may be applied together using coating technique, such as, for example, physical or vapor deposition, spraying, plating, powder coating, or through other chemical or electrochemical techniques. In a particular embodiment, the low friction layer 504 may be applied by a roll-to-roll coating process, including for example, extrusion coating. The low friction layer 504 may be heated to a molten or semi-molten state and extruded through a slot die onto a major surface of the substrate 519. In an embodiment, the material strip 5000, 5001, 5002, 5003, may be a single unitary strip of material.

In other embodiments, under step 412 of FIG. 4, any of the layers on the material strip 5000, 5001, 5002, 5003 as described above in reference to FIGS. 5A-5D, as described above, may be applied by a coating technique, such as, for example, physical or vapor deposition, spraying, plating, powder coating, or through other chemical or electrochemical techniques. In a particular embodiment, the low friction layer 504 may be applied by a roll-to-roll coating process, including for example, extrusion coating. The low friction layer 504 may be heated to a molten or semi-molten state and extruded through a slot die onto a major surface of the substrate 519. In another embodiment, the low friction layer 504 may be cast or molded.

In an embodiment, the low friction layer 504 or any layers can be glued to the substrate 519 using the melt adhesive layer 521 to form a laminate. In an embodiment, any of the intervening or outstanding layers on the material strip 5000, 5001, 5002, 5003, may form the laminate. The laminate can be cut into strips or blanks that can be formed into the material strip. The cutting of the laminate may include use of a stamp, press, punch, saw, or may be machined in a different way. The material strip may then be formed by stamp, press, punch, saw, rolling, flanging, deep-drawing, or may be machined in a different way to fit the shape of the core or housing as described above. In particular embodiment, the material strip 5000 may be molded directly to one of the core or the housing. In another embodiment, the material strip 5000 may be molded to the core or housing as a layer on the component, resulting in a layered structure similar to FIG. 5B. In still another embodiment, the material strip 5000 may be adhesively affixed to the core or housing as a layer on the component with an adhesive layer therebetween, resulting in a layered structure similar to FIG. 5C. In another embodiment, the material strip 5003 may be affixed in total to the core or housing. After shaping the semi-finished material strip, the semi-finished material strip may be cleaned to remove any lubricants and oils used in the forming and shaping process. Cleaning may include chemical cleaning with solvents and/or mechanical cleaning, such as ultrasonic cleaning.

The bearing assemblies of the tracker assemblies of the embodiments herein can demonstrate improved operations and characteristics over conventional bearing assemblies of the tracker assemblies. For example, in one embodiment, the bearing assemblies of embodiments herein demonstrate improved resistance to corrosion and weathering. Further, bearing assemblies of embodiments herein demonstrate improved stick-slip performance properties due to the material strip, which are an improvement over conventional bearing members. Further, bearing assemblies of embodiments herein may allow for swinging the core and rail, allowing for compensation of axial misalignments between multiple bearing assemblies and/or tracker assemblies that may compensate for ground/land undulations or misalignment. Lastly, the bearing assemblies of embodiments herein may allow for increased degrees of freedom to track the sun better and provide for better efficiency of use of the tracker assembly. Therefore, bearing assemblies of the tracker assemblies of the embodiments herein may improve efficiency, provide lower maintenance, lower the cost of installation, and better ease of assembly, and therefore, increase potential deployment of tracker assemblies and/or renewable energy structures.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A power generation structure bearing assembly comprising: a housing adapted to support a rail, wherein the housing comprises a first housing member operatively attached to a support beam having a central axis, and an second housing member operatively attached to the rail, wherein the housing allows for movement of the rail in three degrees of freedom relative to the central axis with a mechanical stop on movement in at least one degree of freedom.

Embodiment 2: A power generation structure bearing assembly comprising: a housing adapted to support the rail, the housing comprising: a first housing member operatively attached to a support beam having a central axis, and a second housing member; wherein the second housing member comprises a core operatively attached rail and a second housing member component, wherein a low friction material is present at an interface between an exterior surface of core and an interior surface of the second housing member component, wherein the housing allows for movement of the rail in three degrees of freedom relative to the central axis with a mechanical stop on movement in at least one degree of freedom.

Embodiment 3: A tracker assembly of a power generation structure comprising: a support beam having a central axis; a rail; and a bearing assembly operatively attached to the support beam and the rail, the bearing assembly comprising: a first housing member operatively attached to the support beam, and a second housing member; wherein the second housing member comprises a core operatively attached rail and a second housing member component, wherein a low friction material is present at an interface between an exterior surface of core and an interior surface of the second housing member component, wherein the housing allows for movement of the rail in three degrees of freedom relative to the central axis with a mechanical stop on movement in at least one degree of freedom.

Embodiment 4: The bearing assembly or tracker assembly according to any of embodiments 2-3, wherein the core has an interior surface for engaging a rail, wherein the interior surface has a cross-sectional shape that is non-circular.

Embodiment 5: The bearing assembly or tracker assembly according to any of the preceding embodiments, wherein an exterior surface of the rail has a cross-sectional shape that is non-circular.

Embodiment 6: The bearing assembly or tracker assembly according to embodiment 5, wherein the non-circular cross section of the interior surface of the core is complementary to the non-circular cross section of the exterior surface of the rail so as to fix the two components.

Embodiment 7: The bearing assembly or tracker assembly according to any of embodiments 2-6, wherein the second housing member component comprises a first second housing member component and a second second housing member component adapted to function as a clamp around at least one of the rail or the core.

Embodiment 8: The bearing assembly or tracker assembly according to embodiment 7, further comprising a fastener for fastening the first second housing member component to the second second housing member component.

Embodiment 9: The bearing assembly or tracker assembly according to embodiment 8, wherein the fastener comprises at least one of screws, bolts, clamps, clasps, clips, latches, pins, rivets, ties, or nails.

Embodiment 10: The bearing assembly or tracker assembly according to any of the preceding embodiments, wherein the low friction material is fixed to an exterior surface of the core or the rail.

Embodiment 11: The bearing assembly or tracker assembly according to any of the preceding embodiments, wherein the low friction material is fixed to an interior surface of the second housing member.

Embodiment 12: The bearing assembly or tracker assembly according to any of the preceding embodiments, wherein the low friction material comprises a material strip and wherein an exterior surface of the rail, an exterior surface of the core, or an interior surface of the second housing member comprises a groove adapted to accommodate the material strip.

Embodiment 13: The bearing assembly or tracker assembly according to any of the preceding embodiments, wherein the low friction material is preformed according to the shape of the core, the rail, or the housing.

Embodiment 14: The bearing assembly or tracker assembly according to any of the preceding embodiments, wherein the low friction material comprises a thermoplastic polymer.

Embodiment 15: The bearing assembly or tracker assembly according to any of the preceding embodiments, wherein the low friction material comprises a fluoropolymer.

Embodiment 16: The bearing assembly or tracker assembly according to any of embodiments 7-15, further comprising a fastener for fastening the first housing member to the second housing member.

Embodiment 17: The bearing assembly or tracker assembly according to embodiment 16, wherein the fastener comprises at least one of screws, bolts, clamps, clasps, clips, latches, pins, rivets, ties, or nails.

Embodiment 18: The bearing assembly or tracker assembly according to any of the preceding embodiments, further comprising a beam fastener for fastening the first housing member to the support beam.

Embodiment 19: The bearing assembly or tracker assembly according to embodiment 18, wherein the fastener comprises at least one of screws, bolts, clamps, clasps, clips, latches, pins, rivets, ties, or nails.

Embodiment 20: The bearing assembly or tracker assembly according to any of the preceding embodiments, wherein the rail is adapted to support a photovoltaic panel.

Embodiment 21: The bearing assembly or tracker assembly according to any of the preceding embodiments, wherein the first housing member comprises tracks allowing for movement in a y direction along the central axis.

Embodiment 22: The bearing assembly or tracker assembly according to any of the preceding embodiments, wherein the first housing member and second housing member comprise a tongue and groove arrangement allowing for movement in a x direction along the central axis.

Embodiment 23: The bearing assembly or tracker assembly according to any of the preceding embodiments, wherein the first housing member comprises a rotational track allowing for movement in a x-y direction along the central axis.

Embodiment 24: The bearing assembly or tracker assembly according to any of the preceding embodiments, wherein the interior surface of the second housing member comprises a substantially parabolic shape allowing for axial movement of the core or rail along the central axis.

Embodiment 25: The bearing assembly or tracker assembly according to any of the preceding embodiments, wherein the interior surface of the second housing member comprises a substantially parabolic shape allowing for rotational movement of the core or rail along the central axis.

Embodiment 26: The bearing assembly or tracker assembly according to any of the preceding embodiments, wherein the second housing member is adapted to tilt relative to the first housing member in the z direction along the central axis.

Embodiment 27: The bearing assembly or tracker assembly according to any of the preceding embodiments, wherein the at least one mechanical stop restricts or eliminates movement in a x direction along the central axis.

Embodiment 28: The bearing assembly or tracker assembly according to any of the preceding embodiments, wherein the at least one mechanical stop restricts or eliminates movement in a y direction along the central axis.

Embodiment 29: The bearing assembly or tracker assembly according to any of the preceding embodiments, wherein the at least one mechanical stop restricts or eliminates movement in a z direction along the central axis.

Embodiment 30: The bearing assembly or tracker assembly according to any of the preceding embodiments, wherein the at least one mechanical stop comprises a tapered or squared edge.

Embodiment 31: The assembly or tracker assembly according to any of embodiments 2-3, wherein the housing comprises two separate pieces.

Embodiment 32: The assembly or tracker assembly according to embodiment 7, wherein the first second housing member component and the second second housing member component are attached at an acute angle.

Note that not all of the features described above are required, that a region of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of assembly and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A power generation structure bearing assembly comprising:
a housing adapted to support a rail, wherein the housing comprises a first housing member operatively attached to a support beam having a central axis, and a second housing member operatively attached to the rail, wherein the housing allows for movement of the rail in three degrees of freedom relative to the central axis with a mechanical stop on movement in at least one degree of freedom.

2. A power generation structure bearing assembly comprising:
a housing adapted to support the rail, the housing comprising:
a first housing member operatively attached to a support beam having a central axis, and a second housing member; wherein the second housing member comprises a core operatively attached rail and a second housing member component, wherein a low friction material is present at an interface between an exterior surface of core and an interior surface of the second housing member component, wherein the housing allows for movement of the rail in three degrees of freedom relative to the central axis with a mechanical stop on movement in at least one degree of freedom.

3. A tracker assembly of a power generation structure comprising:
a support beam having a central axis;
a rail; and
a bearing assembly operatively attached to the support beam and the rail, the bearing assembly comprising:
a first housing member operatively attached to the support beam, and a second housing member; wherein the second housing member comprises a core operatively attached rail and a second housing member component, wherein a low friction material is present at an interface between an exterior surface of core and an interior surface of the second housing member component, wherein the housing allows for movement of the rail in three degrees of freedom relative to the central axis with a mechanical stop on movement in at least one degree of freedom.

4. The bearing assembly of claim 2, wherein the core has an interior surface for engaging a rail, wherein the interior surface has a cross-sectional shape that is non-circular.

5. The bearing assembly of claim 1, wherein an exterior surface of the rail has a cross-sectional shape that is non-circular.

6. The bearing assembly of claim 2, wherein the second housing member comprises a first second housing member component and a second second housing member component adapted to function as a clamp around at least one of the rail or the core.

7. The tracker assembly of claim 3, wherein the low friction material is fixed to an exterior surface of the core or the rail.

8. The tracker assembly of claim 3, wherein the low friction material is fixed to an interior surface of the second housing member.

9. The tracker assembly of claim 3, wherein the low friction material comprises a material strip and wherein an exterior surface of the rail, an exterior surface of the core, or an interior surface of the second housing member comprises a groove adapted to accommodate the material strip.

10. The bearing assembly of claim 7, further comprising a fastener for fastening the first housing member to the second housing member.

11. The tracker assembly of claim 3, further comprising a beam fastener for fastening the first housing member to the support beam.

12. The tracker assembly of claim 3, wherein the first housing member comprises tracks allowing for movement in a y direction along the central axis.

13. The tracker assembly of claim 3, wherein the first housing member and second housing member comprise a tongue and groove arrangement allowing for movement in a x direction along the central axis.

14. The tracker assembly of claim 3, wherein the first housing member comprises a rotational track allowing for movement in a x-y direction along the central axis.

15. The tracker assembly of claim 3, wherein the interior surface of the second housing member comprises a substantially parabolic shape allowing for axial movement of the core or rail along the central axis.

16. The tracker assembly of claim 3, wherein the interior surface of the second housing member comprises a substantially parabolic shape allowing for rotational movement of the core or rail along the central axis.

17. The tracker assembly of claim 3 wherein the second housing member is adapted to tilt relative to the first housing member in the z direction along the central axis.

18. The tracker assembly of claim 3, wherein the at least one mechanical stop restricts or eliminates movement in a x direction along the central axis.

19. The tracker assembly of claim 3, wherein the at least one mechanical stop restricts or eliminates movement in a y direction along the central axis.

20. The tracker assembly of claim 3, wherein the at least one mechanical stop restricts or eliminates movement in a z direction along the central axis.
